(19) United States
(12) Patent Application Publication
(10) Pub. No.: US 2009/0107090 A1
(43) Pub. Date: Apr. 30, 2009

(54) Quick Connect Air Fitting with Integral Filter

(76) Inventor: Shawn Keel, Rock Hill, SC (US)

Correspondence Address: B. CRAIG KILLOUGH, P. O. DRAWER H, CHARLESTON, SC, 29402, US

(21) Appl. No.: 11/931,834

(22) Filed: Oct. 31, 2007

(51) Int. Cl. B01D 50/00

(52) U.S. Cl. 55/385.4

(57) ABSTRACT

A fitting comprising a filter that is used inline in a compressed air supply system. The present invention comprises a fitting body that is adapted to connect to a fitting of a compressed air supply line. A filter element is placed inside of the fitting body. An end of the filter element is closed. The closed end is upstream of the supply of compressed air from an opposite end of the filter element. The filter element removes dirt and particulate materials that are transported through the air supply line to, for example, an air tool.

### FIELD OF THE INVENTION

This invention relates to compressed air supply and to air tools that are driven by compressed air, and is more specifically directed to a fitting comprising a filter for inline use with a compressed air supply.

### BACKGROUND OF THE INVENTION

Compressed air is used to supply power to tools that are actuated by compressed air. In an elemental form, an air compressor supplies air to an air receiver tank which, in turn, supplies regulated compressed air through a supply line. Other elements may be included, such as filters, lubricators and appropriate fittings. Air compressors are available in a wide variety of capacities, both as to pressure and to the volume of compressed air produced. Air tools are used in many applications, including impact wrenches, more sophisticated torqing devices, grease guns, nailers, spray painting devices, and others. In each case, an air supply line is connected to the air tool.

Some air tools are hand-held. These air tools may have a quick disconnect fitting. The air supply line has a portion of a quick disconnect fitting that attaches to the fitting of the air tool. The air supply line for hand-held devices is typically a flexible hose, which allows the hand-held air tool to be manipulated by the operator virtually at will, with minimal interference from the hose. The quick disconnect fitting allows the tool to be attached to another hose in a remote location, or alternatively, allows a different tool to be attached to the hose. The air tool may be easily removed from the air hose for various reasons, such as maintenance, or the attachment of other tools to the air tool, or for refilling the air tool with paint, nails, or other objects as appropriate.

In common use, when hand-held air tools are disconnected from the supply hose, the hose is dropped on the ground or on the floor. Dirt and contaminants enter the open end of the supply line, or alternatively, enter the open end of the fitting that is associated with the air tool. Further, the air compressor and the supply line can be sources of dirt and other contaminants that are transported by the compressed air from the compressor or supply line to the tool. Dirt and contaminants within an air tool is a source of accelerated wear for the tool. Filters are used in air supply lines, but filters of the prior art are generally upstream of the tool itself, meaning that dirt and contaminants can enter the air supply line, such as at the fitting that connects the supply hose to the tool.

### SUMMARY OF THE INVENTION

The present invention is a fitting that is used inline in a compressed air supply system. The present invention comprises a fitting body that is adapted to connect to a fitting of a compressed air supply line. A filter element is placed inside of the fitting body. An end of the filter element is closed. The closed end is upstream of the supply of compressed air from an opposite end of the filter element. The filter element removes dirt and particulate materials that are transported through the air supply line to, for example, an air tool.

### DESCRIPTION OF THE DRAWINGS

FIG. 1 is an exploded view of a filter element of a preferred embodiment of the invention and a fitting body.

FIG. 2 is an elevation of a fitting body of a preferred embodiment of the present invention, with a filter element therein, shown as a phantom.

FIG. 3 is a schematic diagram demonstrating an air supply line with the fitting on an end thereof, with an air tool having a fitting body according to the present invention mounted therein.

FIG. 4 is a schematic diagram demonstrating an air supply line with a female quick disconnect fitting on an upstream end of thereof, with a male fitting on a downstream segment of the air supply line.

### DETAILS OF THE DESCRIPTION OF THE PREFERRED EMBODIMENT

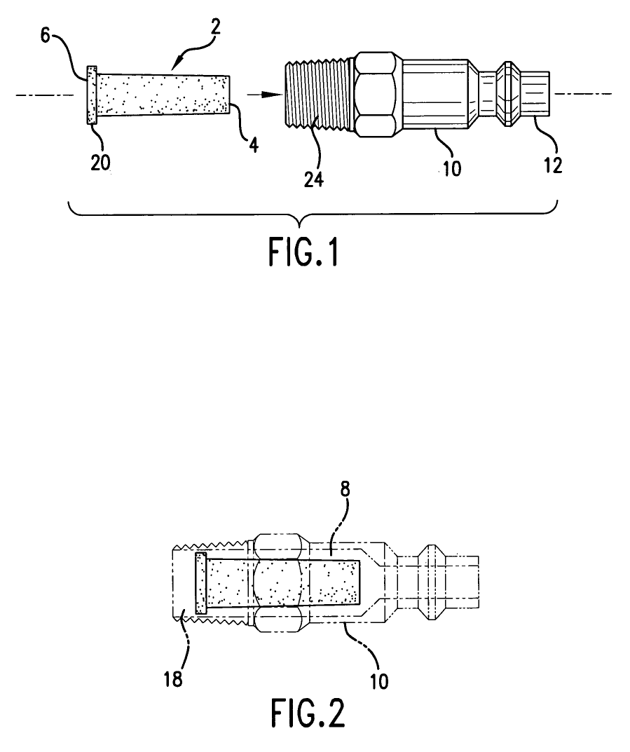

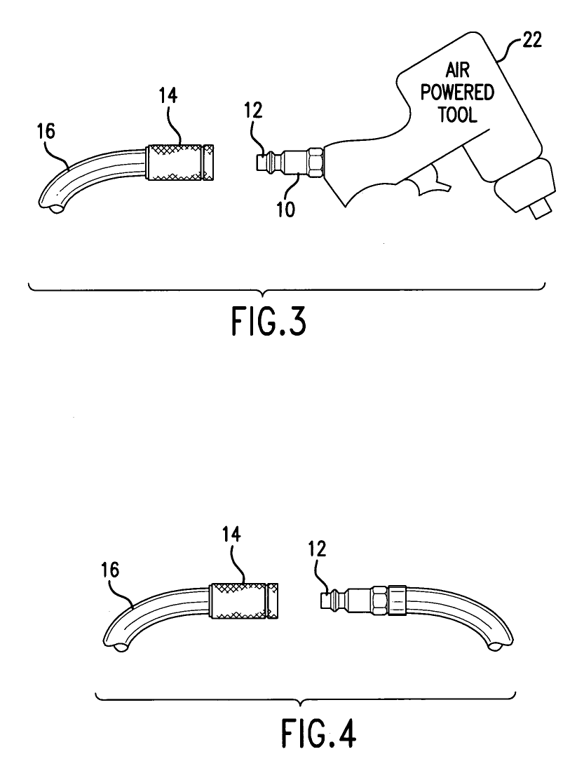

FIG. 1 shows a preferred embodiment of the present invention. A filter element 2 according to an embodiment of the invention has an elongated shape. The filter element may be general cylindrical, and may be tapered from one end 4 to an opposite end 6, with the opposite end being relatively large as compared to end 4. The generally tapered cylinder may be referred to as having a frusto-conical shape. End 4 of the filter element is preferred to be closed, that is, the filter element is formed of filter material on that end, so that air passes through the filter element at the end, and is filtered by the filter element. Opposite end 6 in one embodiment is open, that is, there is no filter material on or covering the opposite end, so as to improve air flow.

The filter element engages a bore 8 in a fitting body 10. The term “bore” is used to indicate an opening or cavity in the filter body that receives the filter within the fitting body, as shown in FIG. 2. The term “bore” is not limited to a cavity that is formed by boring into the fitting body, although the bore could be formed in such a manner if desired. The bore is preferred to be of sufficient size to provide spacing around and between the entire perimeter of the filter element as it is present in the fitting body. The relatively large bore allows air to flow around substantially all of the outside of the filter element, so as to maximize the contact of the surface of the filter element with the air flow, while minimally restricting air flow through the fitting body and filter element. The use of the tapered shape of the filter element further provides additional surface area through which the compressed air passes.

The use of a closed end on the upstream end of the filter element prevents the interior of the filter element from collecting dirt and contaminants that could clog the filter element. In other words, the cup-like shape of the filter element is preferred to be oriented in the compressed air stream so that the “inside” of the cup-like shape of the filter does not trap dirt and contaminants which could prematurely clog the filter.

The filter element may be formed of commonly used filtration materials. It is preferred that the filter element comprise metals, such as brass, that resist sand, metal particles, or other relatively hard particles that are traveling through the air supply line at a high velocity. The filter element may comprise sintered brass.

In one embodiment, the bore 8 is formed in the fitting body 10. The fitting body may have a male connector 12 on one end that engages a female connector 14 of an air supply line 16. An enlarged bore, or counter-bore 18, may be formed in the fitting body on the downstream side of the fitting body. An enlarged end 20 of an embodiment of the filter element engages the counter-bore, so as to permit the filter element to slide into, or slidably engage, the fitting body, with the enlarged end of the filter element and the counter-bore limiting the travel of the filter element within the filter body. FIG. 1 and FIG. 2. After the filter element is positioned within the fitting body, the fitting body engages an air supply line or a body of an air tool 22, such as by threaded engagement 24. The threaded engagement of the fitting body with the air tool or the air supply line prevents the filter element from exiting the fitting body as air pressure is applied against the closed end of the filter element.

In use, the filter element is installed in the fitting body by sliding the filter element in to the fitting body, as demonstrated by FIG. 1 and FIG. 2. A space is present between the sides of the fitting body as defined by the bore and the external sides of the filter element and the closed end of the filter element. The fitting body is then installed, such as by threading the fitting body into a housing of an air tool, so that the opposite end of the filter element is present within the housing of the air tool. Alternatively, the fitting body is threaded into the female threads and an air supply line, such as an air hose, that is downstream from the compressor, so that the opposite end of the filter element is within the female fitting of the downstream air supply line. The air supply line or lines and air tool are used in a normal manner. The quick connect male fitting may be disconnected from a corresponding quick connect female fitting in a normal manner, without regard to the presence of the filter element. In the event that dirt or contaminants enter the fitting body, or otherwise enter the air supply line, the internal filter element prevents most dirt and particulate contaminants from entering the air tool. Dirt and contaminants can be removed from the fitting body by disconnecting the quick disconnect, and tapping the fitting body so that the contaminants fall from the open end of the fitting body.

From time to time, it may be necessary to replace the filter element. The fitting body is removed from the air tool or the downstream air supply line, such as by disengaging the threads of the fitting body. The internal filter element may be removed by sliding it from the fitting body, and replacing the fitting body with a new filter element. In some instances, the filter element may simply be cleaned, such as back flowing air or fluids through the filter element, or by the use of solvents.

What is claimed is:

1. A fitting for a compressed air supply, comprising:
a) a fitting body adapted to connect to a fitting of a compressed air supply line; and
b) a filter element that is positioned inside of said fitting body, wherein an end of said filter element is closed, and wherein said end of said filter element that is closed is upstream of a supply of compressed air from an opposite end of said filter element.

2. A fitting for a compressed air supply as described in claim 1, wherein said fitting body has a male adapter that engages a female adapter of said filling of said compressed air supply line.

3. A fitting for a compressed air supply as described in claim 1, wherein said filter element is elongated and generally cylindrical.

4. A fitting for a compressed air supply as described in claim 1, and wherein said opposite end of said filter element is enlarged relative to said opposite end.

5. A fitting for a compressed air supply as described in claim 4, wherein said opposite end of said filter element is open.

6. A fitting for a compressed air supply as described in claim 1, wherein said filter element is tapered from a relatively larger opposite end to a relatively smaller closed end.

7. A fitting for a compressed air supply as described in claim 1, wherein said filter element comprises a sintered metal.

8. A fitting for a compressed air supply as described in claim 1, wherein said fitting body attaches to an air tool.

9. A fitting for a compressed air supply as described in claim 8, wherein threads of said fitting body engage threads of said air tool.

10. A fitting for a compressed air supply as described in claim 1, wherein said filter element is completely contained within an internal bore of said fitting body.

11. A fitting for a compressed air supply as described in claim 1, wherein said filter element slidably engages an internal bore of said fitting body.

12. A fitting for a compressed air supply, comprising:
a) a fitting body adapted to connect on one end to a fitting of a compressed air supply line by a male engagement on said fitting body with a female engagement fitting on said compressed air supply line, wherein an opposite end of said fitting body engages an opening in an air tool; and
b) an elongated filter element that is positioned inside of a bore formed in said fitting body, wherein an end of said elongated filter element is closed, and wherein said end of said elongated filter element that is closed is upstream of a supply of compressed air from an opposite end of said elongated filter element.

13. A fitting for a compressed air supply as described in claim 12, wherein said opposite end of said elongated filter element is adjacent to said air tool and opposite said supply line.

14. A fitting for a compressed air supply as described in claim 13, wherein said opposite end of said elongated filter element is within a portion of said bore of said fitting body that is within a housing of said air tool.

15. A fitting for a compressed air supply as described in claim 12, wherein said opposite end of said fitting body has a counterbore therein, and wherein said opposite end of said elongated filter element is enlarged, and said enlarged end engages said counterbore.

16. A fitting for a compressed air supply as described in claim 15, wherein said opposite end of said elongated filter element is within a portion of said counter bore of said fitting body that is within a housing of said air tool.

17. A fitting for a compressed air supply as described in claim 12, wherein said elongated filter element is generally cylindrical.

18. A fitting for a compressed air supply as described in claim 12, wherein said opposite end of said elongated filter element is open.

19. A fitting for a compressed air supply as described in claim 12, wherein said elongated filter element is tapered from a relatively larger opposite end to a relatively smaller closed end.

20. A fitting for a compressed air supply as described in claim 12, wherein said elongated filter element comprises a sintered metal.

21. A fitting for a compressed air supply as described in claim 12, wherein threads of said fitting body engage threads of said air tool.

22. A fitting for a compressed air supply as described in claim 12, wherein said elongated filter element is completely contained within said internal bore of said fitting body.

23. A fitting for a compressed air supply as described in claim 1, wherein said elongated filter element slidably engages said internal bore of said fitting body.
